(19) United States
(12) Patent Application Publication
(10) Pub. No.: US 2023/0274127 A1
(43) Pub. Date: Aug. 31, 2023

(54) METHOD AND APPARATUS FOR LEARNING CONCEPT BASED FEW-SHOT

(71) Applicant: ELECTRONICS AND TELECOMMUNICATIONS RESEARCH INSTITUTE, Daejeon (KR)

(72) Inventors: Hyun Woo KIM, Daejeon (KR); Jeon Gue PARK, Daejeon (KR); Hwajeon SONG, Daejeon (KR); Jeongmin YANG, Daejeon (KR); Byunghyun YOO, Daejeon (KR); Euisok CHUNG, Daejeon (KR); Ran HAN, Daejeon (KR)

(73) Assignee: ELECTRONICS AND TELECOMMUNICATIONS RESEARCH INSTITUTE, Daejeon (KR)

(21) Appl. No.: 18/088,428

(22) Filed: Dec. 23, 2022

(30) Foreign Application Priority Data
Feb. 25, 2022 (KR) 10-2022-0024889

(51) Int. Cl. G06N 3/045; G06F 18/15; G06F 18/213; G06F 18/22

(52) U.S. Cl. CPC G06N 3/045; G06F 18/15; G06F 18/213; G06F 18/22

(57) ABSTRACT

A concept based few-shot learning method is disclosed. The method includes estimating a task embedding corresponding to a task to be executed from support data that is a small amount of learning data; calculating a slot probability of a concept memory necessary for a task based on the task embedding; extracting features of query data that is test data, and of the support data; comparing local features for the extracted features with slots of a concept memory to extract a concept, and generating synthesis features to have maximum similarity to the extracted features through the slots of the concept memory; and calculating a task execution result from the synthesis feature and the extracted concept by applying the slot probability as a weight.

### CROSS-REFERENCE TO RELATED APPLICATION

This application claims priority to and the benefit of Korean Patent Application No. 10-2022-0024889, filed on Feb. 25, 2022, the disclosure of which is incorporated herein by reference in its entirety.

### BACKGROUND

### 1. Technical Field

The present disclosure relates to a concept based few-shot learning method and apparatus using concept extraction for executing tasks with a small amount of data.

### 2. Related Art

Recently, research is being actively conducted on the few-shot learning technique that learns a new task using only a small amount of data. However, in the case of few-shot learning according to the related art, there is a large difference from the actual correct answer, and in the case of some related art, there is a problem requiring prior knowledge.

### SUMMARY

The problem to be solved by the present disclosure is a concept based few-shot learning method and apparatus that provide few-shot learning in which a concept suitable for a task can be extracted without prior knowledge of the attribute text of a class in order to execute tasks with a small amount of data.

However, the problem to be solved by the present disclosure is not limited to the above problem, and other problems may exist.

A concept based few-shot learning method according to the first aspect of the present disclosure for solving the above problems includes: estimating a task embedding corresponding to a task to be executed from support data that is a small amount of learning data; calculating a slot probability of a concept memory necessary for a task based on the task embedding; extracting features of query data that is test data, and of the support data; comparing local features for the extracted features with slots of a concept memory to extract a concept, and generating synthesis features to have maximum similarity to the extracted features through the slots of the concept memory; and calculating a task execution result from the synthesis feature and the extracted concept by applying the slot probability as a weight.

Additionally, the concept based few-shot learning apparatus according to the second aspect of the present disclosure includes: a concept memory for storing a concept feature extracted through learning from base data; a task estimation unit for extracting digitized task features from support data, which is a small amount of learning data, and for estimating task embedding based on context information of extracted tasks; a concept attention focusing unit for calculating a slot probability of a concept memory necessary for a task based on the task embedding; a feature extraction unit for extracting features of query data that is test data, and of the support data; a concept extraction and synthesis feature generation unit for comparing a local feature for the extracted features with slots of a concept memory to extract a concept, and for generating a synthesis feature having maximum similarity with the extracted features; and a task execution unit for calculating a task execution result from the synthesis feature and the extracted concept by applying the slot probability as a weight.

Additionally, a learning method for concept based few-shot learning according to the third aspect of the present disclosure includes: batch-sampling a task from base data, and generating an episode constructed with support data and query data in each sampled task; extracting features for the generated episode; generating a synthesis feature and a concept for the extracted features; calculating a task execution result from the synthesis feature and the extracted concept by applying the slot probability of the concept memory as a weight; calculating a task loss based on a difference between a correct answer and the task execution result, and calculating a synthesis loss based on a distance between the extracted features and the synthesis feature; and updating a model parameter such that a total loss obtained by adding the synthesis loss to the task loss is minimized.

A computer program according to another aspect of the present disclosure for solving the above problems is combined with a computer, which is hardware, to execute the concept based few-shot learning method, and is stored in a computer-readable recording medium.

Other specific details of the disclosure are included in the detailed description and drawings.

According to one embodiment of the present disclosure described above, by updating the model parameters to be similar to features of the support data and the query data from the concept memory, it is possible to alleviate the constraint of obtaining prior knowledge of the attribute text of the class and expand the application range of the few-shot learning.

In addition, it is possible to improve task performance compared to the prior art by estimating an accurate task using context information of the support data and limiting unnecessary concept memory unrelated to the task to be executed.

Effects of this disclosure are not limited to the effects mentioned above, and other effects not mentioned above can be clearly appreciated by those skilled in the art from the description below.

### BRIEF DESCRIPTION OF THE DRAWINGS

FIG. 1 is a block diagram of a concept based few-shot learning apparatus according to an embodiment of the present disclosure.

FIG. 2 is a block diagram of a concept based few-shot learning apparatus according to an embodiment of the present disclosure.

FIG. 3 is a flowchart of a concept based few-shot learning method according to an embodiment of the present disclosure.

FIG. 4 is a flowchart of a learning method for concept based few-shot learning according to an embodiment of the present disclosure.

### DETAILED DESCRIPTION

Advantages and characteristics of the invention, and methods of achieving them will become apparent with reference to the embodiments described below in detail in conjunction with the accompanying drawings. However, the present disclosure is not limited to the embodiments disclosed below, but will be implemented in a variety of different forms, and the present embodiments are only provided so that the disclosure of the present disclosure is complete, and to fully inform those of ordinary skill in the art to which the present disclosure belongs, of the scope of the invention, and the present disclosure is only defined by the scope of the claims.

As used herein, the terms are for the purpose of describing the embodiments, and are not intended to limit the present disclosure. Herein, terms in the singular form also relate to the plural form unless specifically stated otherwise in the context. As used herein, the terms “comprises” and/or “comprising” do not preclude the presence or addition of at least one component other than the recited elements. Like reference numerals refer to like elements throughout the specification, and “and/or” includes each and every combination of one or more of the recited elements. Although “first”, “second”, etc. are used to describe various components, these components are not limited by such terms, of course. These terms are only used to distinguish one component from another. Accordingly, it goes without saying that the first element mentioned below may also be the second element within the technical spirit of the present disclosure.

Unless otherwise defined, all terms (including technical and scientific terms) used herein have the same meaning as commonly understood by those skilled in the art to which this invention belongs. In addition, terms defined in commonly used dictionaries are not interpreted ideally or excessively unless explicitly specifically defined.

Hereinafter, the background from which the present disclosure was conceived will be described in order to aid the understanding of those skilled in the art, and then the present disclosure will be described in detail.

Deep learning technology requires a variety of high-quality data and enormous computing resources necessary for model learning. In contrast, humans are capable of rapid and efficient learning. At this time, a technique of learning a new task using only a small amount of data is called a few-shot learning technique.

The few-shot learning technology can be largely classified into a distance-based method, an optimization-based method, and a model-based method. The distance-based few-shot learning is a method of selecting the category of the nearest data in the feature space after learning a feature extraction method in which the distance becomes closer if the categories of the two data are the same, and the distance further increases if they are different from each other. And optimization-based few-shot learning is a method for finding an initial value or update method of a model that produces good performance with a small number of updates for a new task. In addition, the model-based few-shot learning is a method for obtaining a model or feature that produces good performance for a new task by an internal structure such as a meta-learner or memory.

However, in the case of the few-shot learning of the above methods, there is a problem in that its performance is low. The features extracted with the neural network model trained in the above methods have a large variance and a large difference in average compared to actual correct answers.

Accordingly, recently, concept based or semantic-based schemes have been proposed. For example, classification is executed by extracting partial attributes of an image in the field of image category classification and matching the extracted partial attributes with attribute text of a class. However, this method has a problem in that it should be assumed that the attribute text of the class is given as prior knowledge.

In order to address such problem, the concept based few-shot learning method according to an embodiment of the present disclosure performs the few-shot learning using concept extraction suitable for the task without prior knowledge of the attribute text of the class to perform tasks with small amounts of data.

More specifically, an embodiment of the present disclosure sets a concept memory, which is a storage for remembering concept feature, estimates a task to be executed in consideration of the context of support data, and then limits a range of the concept memory suitable for the task. Then, concepts are extracted by comparing local features of the support data and query data with the concept memory, and feature synthesis is executed so that they are similar to features of the support data and query data from the concept memory.

In addition, according to an embodiment of the present disclosure, a total loss may be calculated by adding a synthesis loss to a task loss, and model parameters may be updated to minimize the total loss.

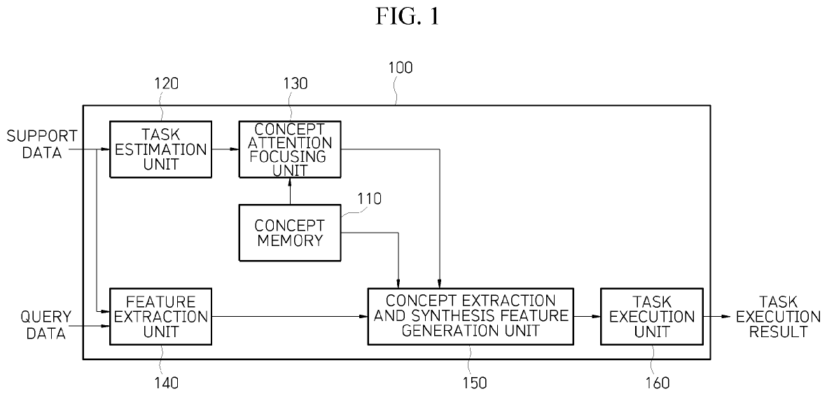

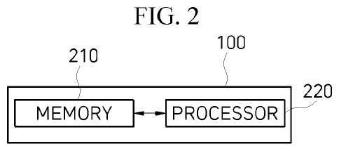

Hereinafter, a concept based few-shot learning apparatus according to an embodiment of the present disclosure will be described with reference to FIGS. 1 and 2.

FIG. 1 is a block diagram of a concept based few-shot learning apparatus according to an embodiment of the present disclosure. FIG. 2 is a block diagram of a concept based few-shot learning apparatus according to an embodiment of the present disclosure.

Meanwhile, as used herein, a small amount of learning data in a task to be executed is referred to as support data, and test data is referred to as query data. And, a large amount of learning data which is not a task to be executed is referred to as a base data.

In one example, when the task to be executed in the field of image category classification is to classify dogs, cats, and elephants, the images marked with the categories are called support data, and the images subjected to the category classification are called query data. And the images marked with categories of dogs, cats, elephants, and other animals as well are called base data.

A concept based few-shot learning apparatus according to an embodiment of the present disclosure is constituted with a memory and a processor that executes a program stored in the memory, and includes a concept memory, a task estimation unit, a concept attention focusing unit, a feature extraction unit, a concept extraction and synthesis feature generation unit, and a task execution unit which are executed by a processor.

First, the concept memory stores concept features extracted through learning from the base data. That is, the concept memory is a storage that stores concept features. For example, in the field of performing category classification for animal images, concepts correspond to a long nose, thin legs, wide wings, and the like. The features of the concept are expressed as digitized vectors, and are not given as prior knowledge, but are extracted through learning based on base data.

The task estimation unit extracts digitized vector-type task features from the support data, and estimates a task embedding based on the context information of the extracted tasks.

In one embodiment, the task estimation unit extracts task features by inputting support data to the first neural network model. For example, in the field of image category classification, the first neural network model may be constructed using a ‘multi-layer convolutional neural network-batch normalization-pooling-nonlinear function’ that has strengths in image processing. Support data is set as input to the input terminal of the first neural network model, and task features may be extracted by applying global average pooling (GAP) to the output terminal.

Additionally, the task estimation unit extracts task features including context information by inputting the extracted task features to the second neural network model. For example, the second neural network model may be constructed with multi-layers of bidirectional long short-term memory neural networks, and may obtain, as outputs, task features for which the context information has been considered, by setting the extracted task features to the input terminal of the second neural network model as inputs.

Thereafter, the task estimation unit estimates task embedding by connecting the task features including the context information and inputting them to the third neural network model. In an embodiment, the third neural network model may be a multi-layer perceptron (MLP), connect the task features including the context information, set them to the MLP as inputs, and obtain a task embedding to be executed as an output.

Meanwhile, the first to third neural network models are obtained through learning based on a large amount of already prepared base data.

Next, the concept attention focusing unit calculates the slot probability of the concept memory required for the task based on the task embedding obtained through the task estimation unit.

For example, in the field of image categories, the concepts required for the task of classifying dogs, cats, and elephants and the task of classifying eagles, magpies, and sparrows are different, so by applying the attention focusing technique to the concept memory and the task embedding, the slot probability of the concept memory required for that task is calculated.

In one embodiment, the concept attention focusing unit may apply each of matrices learned from the base data to slots of the concept memory and the task embedding, and then may calculate a slot probability of a concept memory required for a corresponding task by applying a cosine similarity function and a softmax function.

If the task embedding is \vec{t} and the i-th slot of the concept memory is \vec{mᵢ}, the slot probability pᵢ of the concept memory required for that task is as shown in Equation 1 below.

\vec{a}=A\vec{t}, \vec{bᵢ}=\vec{Bmᵢ}, pᵢ=softmax(cosₛᵢₘ(\vec{a},\vec{bᵢ})), for i=1, . . . , M [Equation 1]

In Equation 1 above, A and B denote matrices learned from base data, and M denotes the total number of memory slots. cos_sim(·) and softmax(·)are the cosine similarity function and the Softmax function, respectively.

In another embodiment, the concept attention focusing unit may limit concepts necessary for a task to be executed by hard decision in order to reduce the amount of calculation. That is, the concept attention focusing unit may calculate the similarity between the slot of the concept memory and the task embedding based on the cosine similarity function, compare the calculated similarity with a preset threshold, and calculate slot probabilities by applying the same weight to the slots of the concept memory whose similarity exceeds a threshold as a result of the comparison.

That is, as shown in Equation 2 below, only concept memory slots in which the similarity between the task embedding and the concept memory slot exceeds a preset threshold are used with the same weight.

$$\begin{matrix}{p}_{i} = \{ \begin{matrix}1 / K , & if cos\_sim ( \vec{a} , {\vec{b}}_{i} ) > THR \\ 0 , & else\end{matrix} , & for i = 1 , … , M\end{matrix} \qquad [ Equation 2 ]$$

In this case, in Equation 2, THR is a threshold value, and K represents the total number of concept memory slots higher than the threshold value.

Next, the feature extraction unit extracts features of the support data and query data. The feature extraction unit extracts features of support data and query data to be compared with the concept memory in the form of digitized vectors. For example, in the case of the field of classifying image categories, similar to the task estimation unit described above, the first neural network model (multi-layer convolutional neural network-batch normalization-pooling-nonlinear function), a first neural network model (multi-layer convolutional neural network-batch regularization-pooling-nonlinear function) with strengths in image processing is constructed, and images of support data and query data are inputted to the first neural network model to extract features as outputs. At this time, the first neural network model is obtained through learning from the base data as described above.

Then, the concept extraction and synthesis feature generation unit compares local features of the extracted features with slots of the concept memory to extract concepts, and generates a synthesis feature having a maximum similarity with the extracted features.

The concept extraction and synthesis feature generation unit generates local features by dividing the extracted features into spaces, and compares the generated local features with concept memory to extract concepts. For example, in the field of classifying image categories, if the features are constructed with a three-dimensional shape of (c×h×w) size, the concept extraction and synthesis feature generation unit obtains hw local features having a dimension of c size by converting the corresponding feature into a two-dimension of (c×hw) size. And, the concept extraction and synthesis feature generation unit calculates the size of the corresponding concept by using attentional focus between local features and the slot of concept memory. In this case, if the j-th local feature is \vec{fₗ}, the concept \vec{e} is extracted as shown in Equation 3 below.

$$\begin{matrix}{{c}_{1}}^{⟶} = C {{m}_{1}}^{⟶} , \\ \vec{{d}_{j}} = D {{f}_{j}}^{⟶} , \\ \begin{matrix}{e}_{i} = {max}_{j} [ {cos}_{sim} \vec{( {c}_{1}} , \vec{{d}_{j} )} ] , & for i = 1 , … , M & for j = 1 , … , hw\end{matrix} \\ \vec{e} = [ {e}_{1} , … , {e}_{M} ]\end{matrix} \qquad [ Equation 3 ]$$

In Equation 3, C and D are matrices learned from the base data.

And, the concept extraction and synthesis feature generation unit calculates a synthesis feature having a maximum similarity with the extracted features by applying the least square method and using a weighted sum from the concept memory. At this time, if the weighted sum is W, the calculated synthesis feature F is as shown in Equation 4.

$$\begin{matrix}F = [ {f}_{1} , … , {f}_{hw} ] , \\ M = [ {m}_{1} , … , {m}_{hw} ] , \\ \hat{W} = {arg min}_{W} {‖ F - WM ‖}^{2} + λ {‖ W ‖}^{2} , \\ \hat{F} = \hat{W} M\end{matrix} \qquad [ Equation 4 ]$$

In this regard, λ in Equation 4 represents a factor that adjusts the size of the normalization term so that the weighted sum becomes a sparse matrix.

Next, the task execution unit calculates a task performance result from the extracted concept and synthesis feature by applying the slot probability as a weight.

In one embodiment, the task execution unit calculates a prototype for the l-th category of support data as an average of concepts of support data, and applies a slot probability as a weight to the concept difference between the calculated prototype and the query data, and calculates a task performance result in which the distance between the prototype and the query data is minimized.

example, in the field of classifying image categories, there are L categories in the support data, and K data in each category, and if the concept of the k-th support data of the l-th category is {right arrow over (eₛ_{_{l,k}})}, the prototype of the l-th category \vec{eₛ_{ₗ}} can be calculated through the average of the concepts of the support data as shown in Equation 5.

$$\vec{{e}_{{s}_{i}}} = \frac{1}{K} {\sum }_{k = 1}^{K} \vec{{e}_{{s}_{i , k}}} \qquad [ Equation 5 ]$$

And if the concept of query data is \vec{e_{q}}, as shown in Equation 6 below, the task execution unit uses the slot probability of the concept memory as a weight to calculate, as a task performance result, a category in which the distance between the prototype and the query data is minimized.

$$= {arg min}_{i} {\sum }_{i}^{M} {p}_{i} {‖ \vec{{e}_{{s}_{i}}} ( i ) - \vec{{e}_{q}} ( i ) ‖}^{2} , l = 1 , … , L \qquad [ Equation 6 ]$$

In another embodiment, the task execution unit calculates a prototype for the l-th category of support data as an average of synthesis features of support data, and applies a slot probability as a weight to the synthesis feature difference between the calculated prototype and the query data, and calculates a task performance result in which the distance between the prototype and the query data is minimized.

For example, in the field of classifying image categories, if the synthesis feature of the k-th support data of the l-th category is {right arrow over (Fₛ_{_{l,k}})}, the prototype of the l-th category \vec{Fₛ_{ₗ}} is calculated through Equation 7.

$$\vec{{F}_{{s}_{i}}} = \frac{1}{K} {\sum }_{k = 1}^{K} \vec{{F}_{{s}_{i , k}}} \qquad [ Equation 7 ]$$

In this regard, if the concept of query data is \vec{F_{q}}, as shown in Equation 8 below, the task execution unit applies the slot probability of the concept memory as a weight to calculate, as a task performance result, a category in which the distance between the prototype and the query data is minimized.

$$= {arg min}_{i} {‖ \vec{{F}_{{s}_{i}}} - \vec{{F}_{q}} ‖}_{P} , l = 1 , … , L \qquad [ Equation 8 ]$$

In this regard, in Equation 8, P is a matrix whose (i,j)th element is pᵢpⱼ, and ∥·˜_{P} represents the Frobenius Norm.

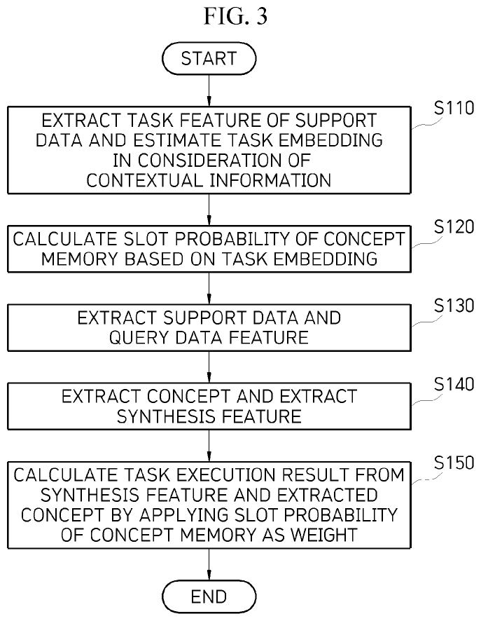

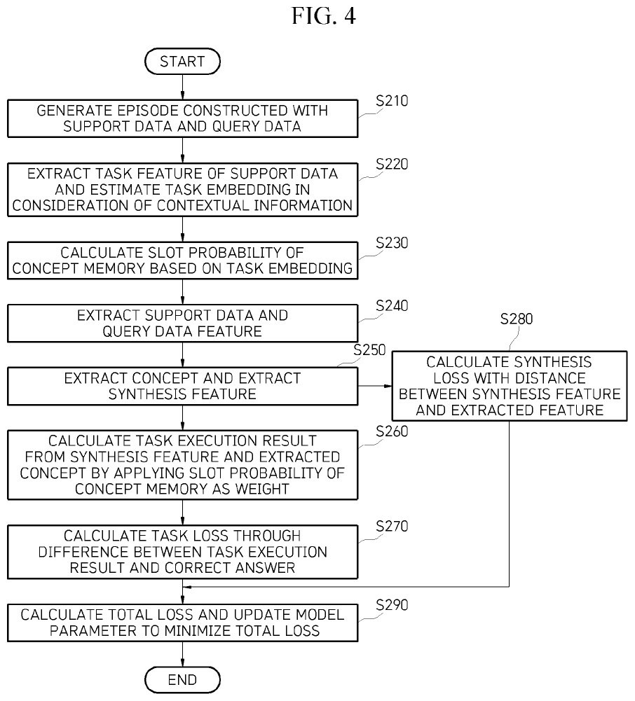

Hereinafter, with reference to FIGS. 3 and 4, a concept based few-shot learning method according to an embodiment of the present disclosure will be described. In this case, it may be understood that the method according to FIGS. 3 and 4 is executed by the above-described concept based few-shot learning apparatus, but is not necessarily limited thereto. In the following description, details redundant with the foregoing content will be omitted, but they are not necessarily excluded.

FIG. 3 is a flowchart of a concept based few-shot learning method according to an embodiment of the present disclosure.

First, a task embedding corresponding to a task to be executed is estimated from support data, which is a small amount of learning data (S110). In step S110, digitized vector-type task features may be extracted from the support data, and the task embedding may be obtained based on context information of the extracted task features.

Next, based on the obtained task embedding, the slot probability of concept memory required for the task is calculated (S120).

Next, features of support data and query data to be compared with the concept memory are extracted in the digitized vector-type ones (S130).

Next, local features are obtained by dividing the extracted features into spaces, and concepts are extracted by comparing the local features with slots in the concept memory. Then, the synthesis feature having the maximum similarity with the features extracted from the concept memory is generated (S140).

Finally, a task execution result is calculated from the extracted concept and the synthesis feature by applying the slot probability of the concept memory as a weight (S150).

FIG. 4 is a flowchart of a learning method for concept based few-shot learning according to an embodiment of the present disclosure.

An embodiment of the present disclosure is based on episode-type meta learning that performs ‘learning for few-shot learning.’ By constructing a type of task similar to the task to be executed with a small amount of data from the base data, and learning new concepts and rules by performing the constructed task, it is possible to learn quickly with a small amount of data.

That is, in an embodiment of the present disclosure, an episode constructed with the support data and the query data is generated by sampling a certain task from base data and sampling some from the data corresponding to that task without overlapping with each other. Then, the model parameters are learned by applying few-shot learning to the generated episodes. The model parameters here correspond to the model parameters for the first to third neural network models described above.

For example, in the field of classifying image categories, when the task to be executed is to classify dogs, cats, and elephants, and there are images marked with categories for dogs, cats, elephants, and other animals from the base data, random categories such as lions, giraffes, and hippos are sampled from all categories in the base data. In addition, images corresponding to lions, giraffes, and hippos are arbitrarily sampled from the base data to construct support data and query data, and model parameters are learned by applying the few-shot learning.

Specifically, tasks are batch-sampled from the base data, and episodes constructed with the support data and the query data are generated in each task (S210).

Next, the digitized vector-type task features of the support data are extracted, and task embeddings are obtained by considering the context information from the extracted task features (S220).

Next, based on the task embedding, the slot probability of the concept memory necessary for the task to be executed is calculated (S230).

Next, features of support data and query data to be compared with the concept memory are extracted in the digitized vector-type ones (S240).

Next, the concept and the synthesis feature are created for the extracted features (S250). In step S250, a concept is extracted by comparing the local features obtained by dividing the extracted features into spaces with the concept memory. Then, the synthesis feature having the maximum similarity with the feature extracted from the concept memory is generated.

Next, a task execution result is calculated from the extracted concept and the synthesis feature by applying the slot probability of the concept memory as a weight (S260).

Next, the task loss is calculated based on the difference between the task execution result and the correct answer (S270). For example, in the field of classifying image categories, maximum likelihood can be applied as a task loss. If the prototype of the correct answer category is \vec{e_{label}}, the maximum likelihood may be expressed as in Equation 9 below.

$${ℒ}_{CE} = \frac{1}{Q} {\sum }_{q = 1}^{Q} log [ softmax ( {\sum }_{i}^{M} {p}_{i} {‖ \vec{{e}_{label}} ( i ) - \vec{{e}_{q}} ( i ) ‖}^{2} ) ] \qquad [ Equation 9 ]$$

At this time, in Equation 9, Q represents the total number of query data, and log[·] represents a logarithmic function.

As another embodiment, if the prototype of the correct answer category is \vec{F_{label}}, the maximum likelihood may be expressed as in Equation 10.

$${ℒ}_{CE} = \frac{1}{Q} {\sum }_{q = 1}^{Q} log [ softmax ( {‖ \vec{{F}_{label}} - \vec{{F}_{q}} ‖}_{P} ) ] \qquad [ Equation 10 ]$$

Next, a synthesis loss is calculated based on the distance between the synthesis feature and the extracted features (S280). For example, in the field of classifying image categories, if \hat{F}ₙ is the extracted feature and Fₙ is the synthesis feature, Euclidean distance is used as the distance between features as shown in Equation 11 below.

$${ℒ}_{rec} = \frac{1}{N} {\sum }_{n = 1}^{N} {‖ {F}_{n} - \hat{{F}_{n}} ‖}^{2} \qquad [ Equation 11 ]$$

In this regard, N in Equation 11 means the total number of support data and query data.

Finally, the total loss is calculated by adding the synthesis loss to the working loss, and the model parameters are updated through stochastic gradient descent to minimize the total loss (S290).

Meanwhile, in the above description, steps S110 to S290 may be further divided into additional steps or combined into fewer steps according to an embodiment of the present disclosure. Also, some steps may be omitted as needed, and the order of steps may be changed. Additionally, even if other omitted contents, the contents of FIGS. 1 and 2 may be applied to the methods of FIGS. 3 and 4.

One embodiment of the present disclosure described above may be implemented as a program (or application) to be executed in combination with a computer, which is hardware, and may be stored in a medium.

The above-described program may include a code coded in a computer language, such as C, C++, JAVA, Ruby, or machine language, that can be read by a processor (CPU) of the computer through a device interface of the computer in order for the computer to read the program and execute the methods implemented in the program. These codes may include functional codes related to functions or the like defining necessary functions for executing the methods, and may include execution procedure-related control codes necessary for the computer's processor to execute the functions according to a predetermined procedure. In addition, these codes may further include additional information necessary for the processor of the computer to execute the functions, or code related to memory reference for which location (address) of the computer's internal or external memory the medium should be referenced from. In addition, if the processor of the computer needs to communicate with any other remote computer or server in order to execute the functions, the code may further include communication-related codes for how to communicate with any other remote computer or server using the communication module of the computer, what kind of information or media should be sent and received when communicating, and the like.

The storage medium is not a medium that stores data for a short moment, such as a register, cache, or memory, but a medium that stores data semi-permanently and is readable by a device. Specifically, examples of the storage medium include ROM, RAM, CD-ROM, magnetic tape, floppy disk, optical data storage device, etc., but are not limited thereto. That is, the program may be stored in various recording media on various servers accessible by the computer, or in various recording media on the user's computer. In addition, the medium may be distributed to computer systems connected by a network, and computer readable codes may be stored in a distributed manner.

The afore-mentioned description of the present disclosure is just an example, and a person having ordinary skill in the art to which the present disclosure pertains may understand that it can be easily modified into other specific configuration without changing the technical idea or essential features of the present disclosure. Accordingly, it should be understood that the embodiments described above are illustrative in all respects and not restrictive. For example, the respective components described as a singular form may be implemented in a distributed form, and the respective components described as a distributed form may be implemented in a combined form.

The scope of the disclosure is defined by the following claims rather than the detailed description, and all modifications derived from the meaning and scope of the claims and equivalents thereto or modified forms should be interpreted as being included in the scope of the disclosure.

What is claimed is:

1. A concept based few-shot learning method executed by a computer, the concept based few-shot learning method comprising:
estimating a task embedding corresponding to a task to be executed from support data that is a small amount of learning data;
calculating a slot probability of a concept memory necessary for a task based on the task embedding;
extracting features of query data that is test data, and of the support data;
comparing local features for the extracted features with slots of a concept memory to extract a concept, and generating synthesis features to have maximum similarity to the extracted features through the slots of the concept memory; and
calculating a task execution result from the synthesis feature and the extracted concept by applying the slot probability as a weight.

2. The concept based few-shot learning method of claim 1, wherein the estimating the task embedding corresponding to the task to be executed from the support data includes:
extracting digitized vector-type task features from the support data; and
estimating the task embedding based on context information of the extracted task features.

3. The concept based few-shot learning method of claim 2, wherein the extracting the digitized vector-type task features from the support data includes:
extracting task features by inputting the support data to a first neural network module; and
extracting task features including context information by inputting the extracted task features to a second neural network module.

4. The concept based few-shot learning method of claim 3, wherein the estimating the task embedding based on context information of the extracted task features includes:
estimating the task embedding by connecting the task features including the context information and inputting the task features including the context information to a third neural network module.

5. The concept based few-shot learning method of claim 4, wherein the first to third neural network modules are learned based on a large amount of already prepared base data.

6. The concept based few-shot learning method of claim 1, wherein the calculating the slot probability of the concept memory necessary for the task based on the task embedding includes:
calculating a slot probability of the concept memory necessary for that task by applying an attention focusing technique to the concept memory and the task embedding.

7. The concept base few-shot learning method of claim 6, wherein the calculating the slot probability of the concept memory necessary for the task based on the task embedding includes:
calculating a slot probability of a concept memory necessary for that task by applying a cosine similarity function and a softmax function after applying each of matrices learned from base data to a slot of the concept memory and the task embedding.

8. The concept base few-shot learning method of claim 6, wherein the calculating the slot probability of the concept memory necessary for the task based on the task embedding includes:
calculating a similarity between the slot of the concept memory and the task embedding based on a cosine similarity function, comparing the similarity with a preset threshold, and calculating slot probability by applying the same weight to a slot of concept memory whose similarity exceeds the threshold as a result of the comparison.

9. The concept based few-shot learning method of claim 1, wherein the calculating the task execution result from the synthesis feature and the extracted concept by applying the slot probability as a weight includes:
calculating a prototype for an l-th category of the support data as an average of the concept of the support data; and
calculating a task execution result in which a distance between the prototype and query data is minimized by applying the slot probability as a weight to a difference between the concept of the query data and the calculated prototype.

10. The concept based few-shot learning method of claim 1, wherein the calculating the task execution result from the synthesis feature and the extracted concept by applying the slot probability as a weight includes:
calculating a prototype for an l-th category of the support data as an average of the synthesis feature of the support data; and
calculating a task execution result in which a distance between the prototype and query data is minimized by applying the slot probability as a weight to a difference between the synthesis feature of the query data and the calculated prototype.

11. The concept based few-shot learning method of claim 1, further comprising:
batch-sampling tasks from base data, generating an episode constructed with support data and query data in each task, and learning a model parameter by applying few-shot learning to the generated episode.

12. The concept based few-shot learning method of claim 11, wherein the learning the model parameter includes:
extracting features for the generated episode;
generating a synthesis feature and a concept for the extracted features;
calculating a task execution result from the synthesis feature and the extracted concept by applying the slot probability of the concept memory as a weight;
calculating a task loss based on a difference between a correct answer and the task execution result, and calculating a synthesis loss based on a distance between the extracted features and the synthesis feature; and
updating a model parameter such that a total loss obtained by adding the synthesis loss to the task loss is minimized.

13. A concept based few-shot learning apparatus comprising:
a concept memory for storing a concept feature extracted through learning from base data;
a task estimation unit for extracting digitized task features from support data, which is a small amount of learning data, and for estimating task embedding based on context information of extracted tasks;
a concept attention focusing unit for calculating a slot probability of a concept memory necessary for a task based on the task embedding;
a feature extraction unit for extracting features of query data that is test data, and of the support data;
a concept extraction and synthesis feature generation unit for comparing a local feature for the extracted features with slots of a concept memory to extract a concept, and for generating a synthesis feature having maximum similarity with the extracted features; and
a task execution unit for calculating a task execution result from the synthesis feature and the extracted concept by applying the slot probability as a weight.

14. The concept based few-shot learning apparatus of claim 13, wherein the task extraction unit extracts task features by inputting the support data to a first neural network module, extracts task features including context information by inputting the extracted task features to a second neural network module, and estimates the task embedding by connecting the task features including the context information and inputting the task features including the context information to a third neural network module.

15. The concept based few-shot learning apparatus of claim 13, wherein the concept attention focusing unit calculates a slot probability of the concept memory necessary for that task by applying an attention focusing technique to the concept memory and the task embedding.

16. The concept based few-shot learning apparatus of claim 15, wherein the concept attention focusing unit calculates a slot probability of a concept memory necessary for that task by applying a cosine similarity function and a softmax function after applying each of matrices learned from base data to a slot of the concept memory and the task embedding.

17. The concept based few-shot learning apparatus of claim 16, wherein the concept attention focusing unit calculates a similarity between the slot of the concept memory and the task embedding based on a cosine similarity function, compares the similarity with a preset threshold, and calculates slot probability by applying the same weight to a slot of concept memory whose similarity exceeds the threshold as a result of the comparison.

18. The concept based few-shot learning apparatus of claim 13, wherein the task execution unit calculates a prototype for an l-th category of the support data as an average of the synthesis feature or concept of the support data, and calculates a task execution result in which a distance between the prototype and query data is minimized by applying the slot probability as a weight to a difference between the synthesis feature or concept of the query data and the calculated prototype.

19. A learning method for concept based few-shot learning executed by a computer, the concept based few-shot learning method comprising:
batch-sampling a task from base data, and generating an episode constructed with support data and query data in each sampled task;
extracting features for the generated episode;
generating a synthesis feature and a concept for the extracted features;
calculating a task execution result from the synthesis feature and the extracted concept by applying the slot probability of the concept memory as a weight;
calculating a task loss based on a difference between a correct answer and the task execution result, and calculating a synthesis loss based on a distance between the extracted features and the synthesis feature; and
updating a model parameter such that a total loss obtained by adding the synthesis loss to the task loss is minimized.
